(19) United States
(12) Patent Application Publication
(10) Pub. No.: US 2007/0170717 A1
(43) Pub. Date: Jul. 26, 2007

(54) Automatically unfoldable card

(76) Inventor: Patrick Dirassuian, La Valette du Var (FR)

Correspondence Address: FISH & RICHARDSON P.C., P.O. BOX 1022, MINNEAPOLIS, MN, 55440-1022, US

(21) Appl. No.: 10/556,208

(22) PCT Filed: May 3, 2004
(86) PCT No.: PCT/FR04/01067

§ 371 Date: Dec. 1, 2006

(30) Foreign Application Priority Data
May 9, 2003 (FR) 03/05613

(51) Int. Cl. B42D 15/00

(52) U.S. Cl. 283/106

(57) ABSTRACT

An unfoldable card (1) comprising first and second portions (2, 3) which are moveable in relation to each other and which are joined to each other by an elastic means (4), said card selectively adopting a closed configuration wherein the elastic means (4) is stressed and the first and second moveable portions (2,3) are moved towards each other, and an open configuration wherein the elastic means is de-stressed and the first and second moveable parts (2,3) are moved away from each other. The card is provided with a blocking means (5) enabling the card to be locked in the closed configuration thereof, said blocking means (5) comprising means causing the card to pass automatically in a delayed manner from the closed configuration to the open configuration.

The present invention generally relates to the field of games and more particularly, the invention relates to an unfoldable card comprising first and second mobile portions relative to one another and interconnected by elastic means, the card selectively adopting a closed configuration in which the elastic means are stressed and the first and second mobile portions are moved towards one another and an open configuration in which the stress of the elastic means is released and the first and second mobile portions are moved away from one another.

So as to create a surprise effect and a diversion, unfoldable systems are often used for revealing a decoration and/or a hidden object of a surprising nature to a user, a player, or a spectator.

This is the reason why numerous makers of joke and novelty objects or games have developed various solutions aimed at animating such entertainment objects to reveal a hidden object by mechanical means.

An unfoldable card of the type previously defined, and applied specifically to the field of greetings. cards, enabling such a surprise effect, is for example described in the patent document U.S. Pat. No. 4,763, 427.

This document offers a greetings card placed in an envelope. This card is a three-dimensional object, pliable, fitted with mobile portions and stressed by elastic. This greetings card is folded flat on itself. In this position, the elastic is stressed and the card is placed in a shipping envelope.

On receipt, the recipient opens the envelope and/or tears a portion of the envelope provided for this effect, which immediately frees the card from out of the envelope and allows it to deploy in 3D.

This card creates a surprise effect triggered when the recipient handles the card.

It is thus desirable to develop a surprising object allowing deployment of a card without the immediate intervention of the user being necessary.

In this context, the object of the present invention is to propose an unfoldable card, capable of deploying without direct intervention by the user.

For this purpose, the unfoldable card of the invention, also in accordance with the generic definition given in the preamble hereinabove, is essentially characterized in that it comprises blocking means of the card in its closed configuration, said blocking means comprising means to have the card pass automatically and in a delayed manner from its closed configuration to its open configuration.

The card according to the present invention is positioned first in a first closed configuration.

Due to the blocking means, the card remains in this configuration for a few moments, then it deploys automatically and delayed, thus triggering a surprise effect.

Preferably, this surprise effect is improved since the card can be adapted to hide, in a closed configuration, a decoration or an object and to reveal this object when it transitions to the open configuration.

For example, it can be arranged for the blocking means to be reused to allow repositioning of the card in its closed configuration.

Therefore, after the card is passed a first time from its closed configuration to its open configuration, it is possible to reutilise it by positioning it again in closed configuration.

It can also be ensured that the blocking means of the card comprise an adhesive resilient over time allowing the mobile portions to be stuck together.

This means is particularly interesting for making blocking means reusable, as it is low cost and simple to manufacture.

It can also be arranged to produce the blocking means by using a supple elastic band comprising at least one adhesion face, with said resilient adhesive applied, this band being adapted to stick together, the first and second mobile portions and thus position the card in its closed configuration.

The advantage of utilizing such a supple elastic band is to create on the band an elastic return stress when it is stuck on the two mobile portions and when the card is in closed configuration.

Under the combined effects of the elastic stress of the elastic band and the elastic stress exerted by the elastic means on the mobile portions, the elastic band has a tendency to progressively unstick to the point where it detaches from one of the mobile portions and allows the card to pass to open configuration.

Other characteristics and advantages of the invention will emerge clearly from the following description, given by way of indication and in no way limiting, in reference to the attached diagrams, in which:

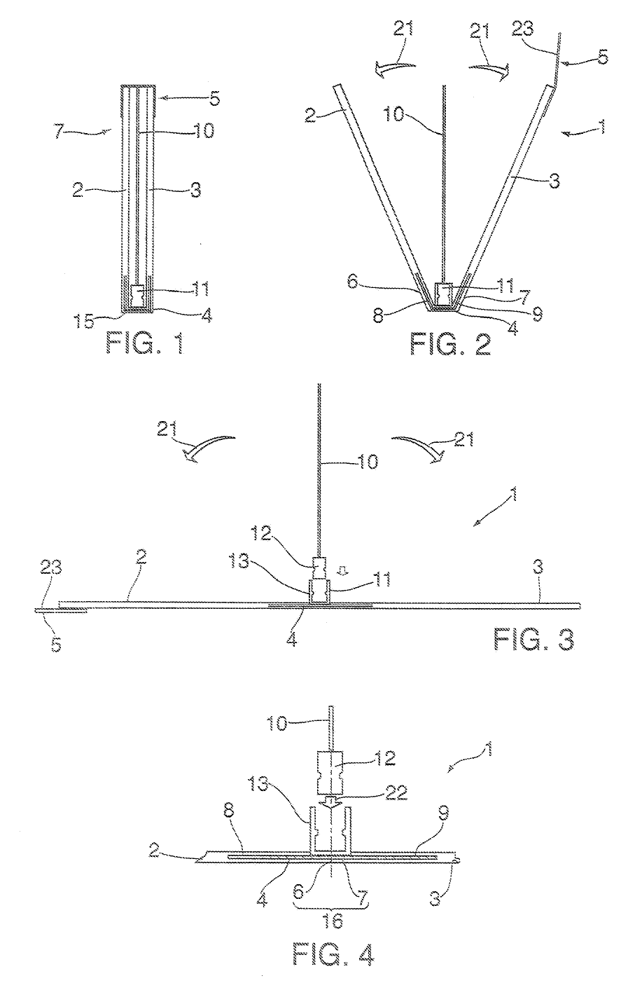

FIG. 1 is a side view of an unfoldable card according to the present invention, in its closed configuration,

FIG. 2 is a side view of the unfoldable card according to the present invention, in an intermediate configuration as it passes from the closed configuration to the open configuration,

FIG. 3 is a side view of the card according to the present invention in its open configuration,

FIG. 4 is a detailed view of the link between the mobile portions of the card according to the present invention,

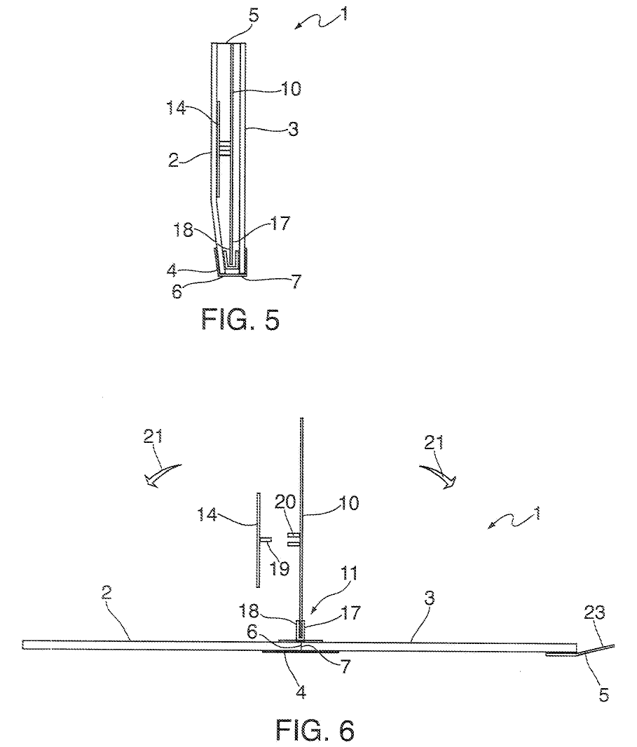

FIG. 5 is a side view of a playing card according to the present invention, in closed configuration and fitted with a decorative piece and a secondary decorative piece,

FIG. 6 is a side view of the card of FIG. 5 in open configuration.

The card in FIGS. 1 to 6 is an unfoldable card 1 which is preferably utilized as a playing card. Such a game is based on the fact of hiding an element, which can be a decorative piece 10 between first and second mobile portions 2 and 3 relative to one another over a certain time, then revealing this element.

For this, the mobile portions 2 and 3 are connected to one another by elastic means 4 and are adapted to pivot relative to one another according to a pivot axis 15 substantially close to the axis of symmetry of the elastic means 4.

In FIG. 1, the card 1 is in closed configuration. In this closed configuration, the elastic means 4 are stressed and the first and second mobile portions 2, 3 are moved towards one another.

Under the effect of the two mobile portions 2 and 3 moving towards one another, the elastic means 4 are folded and stressed elastically.

The first and second mobile portions 2 and 3 are substantially rigid flat pieces, of a shape substantially identical to one another and rectangular.

It is preferable that the materials utilized in such a card do not have to be metallic or easily breakable so as to be utilized in a children's game.

The first and second portions 2 and 3 and other elements making up the card are thus generally made of plastic materials or packaged materials with optionally plasticized surface.

The first mobile portion 2 has a first edge 6, and the second mobile portion 3 has a second edge 7.

These edges 6 and 7 are substantially parallel to one another and serve as supports for fixing to the elastic means 4 which are generally assembled by adhesion along these edges 6 and 7. The elastic means 4 thus form a pivoting elastic hinge of the mobile portions 2 and 3, according to an axis of rotation 15 substantially parallel to the edges 6 and 7.

In other embodiments, the mobile portions 2 and 3 can have forms other than flat and/or other than rectangular. They can for example be in the form of circular or triangular shells.

It is to be noted that in certain alternative embodiments, the axis of rotation 15 of the elastic means 4 acting as hinge can be perpendicular to the principal planes of the substantially flat mobile portions 2 and 3. In this case, the elastic element is generally a jack assembled on each of the surfaces parallel to the principal planes of the mobile portions 12 and 13. In this alternative embodiment, not illustrated in the figures, the elastic means are subjected to torsion according to the axis of rotation 15, when the card is in closed configuration.

In accordance with the embodiments of the invention illustrated in the figures, assembly via elastic means 4 can be done in different ways.

In accordance with a first method of assembly, the elastic means 4 are a flat elastic band inserted and stuck immobile at attachment points 8 and 9 arranged respectively in the thickness of the first and second edges 6 and 7 of the mobile portions 2 and 3. In this embodiment the elastic band 4 connects the edges 6 and 7 of the mobile portions 2 and 3, thus allowing pivoting and alternative passage of the card 1 from its closed configuration to its open configuration and inversely.

In accordance with another method of assembly of the elastic means 4, shown in FIGS. 5 and 6, the elastic means can be several elastic bands combined outside the mobile portions 2 and 3 and on the edges 6 and 7. In this exemplary embodiment of FIG. 5, the two elastic bands are fixed to the faces opposite the edges 6 and 7.

A flat decorative piece 10, hidden by the mobile portions 2 and 3, when the card 1 is in closed configuration, is fixed to a longitudinal portion of the elastic means 4.

This decorative piece 10 can be either detachable from the card to be replaced by the player, as in FIGS. 1 to 4, or fixed and immobile from the card, as in FIGS. 5 and 6.

In these two cases of attachment of the decorative piece 10, attachment means of the latter are located in the vicinity of the edges 6 and 7, at the connection point between the mobile portions 2 and 3. This attachment means is selected so as to have a relatively significant thickness. Therefore, when the card is in its closed configuration, this attachment means 11 of the decorative piece 10 is wedged in between the mobile portions 2 and 3. Such wedging contributes to increasing the stress effort of the elastic means 4.

When this decoration 10 is detachable from the card, as in FIGS. 1 to 4, the attachment means 11 are generally composed of at least one male attachment 12 and one female attachment 13.

The attachment means of the immobile decorative piece 10 are detailed in FIG. 4.

In this embodiment, these attachment means are made up of female attachment 13 directly fixed by adhesion to a surface portion of the elastic means 4.

The hidden portions of the elastic means 4 are inserted into the connection points 8 and 9.

A male attachment 12, of a shape complementary to that of the female attachment 13, intended to come and clip onto the latter, is placed on an edge of the decorative piece 10.

The male attachment 12 is inserted into the female attachment 13 by a translation movement according to the direction of the arrow 22 oriented towards the interior of the female attachment 13.

Once it is inserted, the male attachment 12 is blocked in the female attachment 13 and thus integral with the card 1.

As shown in FIGS. 5 and 6, a secondary decorative piece 14 can likewise be assembled on the decorative piece 10 so as to complete the play appearance of the unfoldable card 1.

This additional decorative piece 14 can for example be a flat piece on which an assembly jack 19 is positioned having a form complementary to a support jack 20 positioned on a plane face of the decorative piece 10.

Due to this assembly, the same card 1 can successively accept several decorative pieces 10 and several additional decorative pieces 14.

The blocking means 5 of the card 1 in its closed configuration are shown in FIGS. 1 to 6.

These blocking means 5 are made up of a supple band 5, preferably elastic. This band is stuck to one of its faces 23 with an adhesive whereof the adhesive properties are resilient, that is, it can be stuck and unstuck several times continuously, relatively retaining the same adhesive characteristics.

This supple band 5 is preferably provided to be removable from the card 1 so as to be interchangeable.

This allows the supple band 5 to be changed when it is worn, for example by soiling, which would prevent proper adhesion of the adhered face 23 of the band 5.

This detachable band 5 is likewise advantageous, since the user can thus choose between several bands so as to augment or delay the opening time of the card, between the moment of its closing and the moment of its opening. The opening time can be augmented with the adhesive surface of the band and/or by using an adhesive with superior adhesive properties.

In the first instance, the user brings together the mobile portions 2 and 3, by pivoting them according to the axis of rotation 15, so a to hide the decorative piece 10.

Then, secondly, the user sticks a portion of the adhered face 23 of the supple band 5 onto one of the mobile portions 2 or 3, then folds this supple band 5 on the card so as to fix the portion of the supple band 5 not yet stuck onto the second mobile portion 2 or 3.

Once blocked in this closed configuration, the card 1 (as shown in FIGS. 1 and 5) can be placed on a support.

The efforts needed to open the card according to the direction of the arrows 21, applied by the elastic means 4, lead to the progressive unsticking of a portion of the supple band 5. This unsticking can be emphasized by using a supple band having elastic capacities. In fact, the supple elastic band will have a tendency to unfold and be substantially flat as shown in FIGS. 2, 3 and 6.

This unsticking can likewise be emphasized by a folding effort of one at least of the faces of the mobile portions 2 or 3, as shown in FIG. 5.

Once fully stuck, the supple band 5 releases the card, which then opens automatically and abruptly according to the direction of the arrows 21.

Under the impact of opening, the card 1 is generally projected into the air relative to the support on which it was resting, and pivots on same.

The card is generally balanced to fall back itself onto the support and leave the decorative piece 10 vertical and visible, as in FIGS. 3 and 6.

1. An unfoldable card comprising first and second mobile portions relative to one another and connected to one another by elastic means, the card selectively adopting a closed configuration in which the elastic means are stressed and the first and second mobile portions are brought together, and an open configuration in which the stress of the elastic means is released and the first and second mobile portions are moved apart from one another, the card being characterized in that it comprises blocking means of the card in its closed configuration, these blocking means comprising means to have the card pass automatically and in delayed fashion from its closed configuration to its open configuration.

2. The unfoldable card as claimed in claim 1, characterized in that the blocking means can be reused for repositioning the card in its closed configuration.

3. The unfoldable card as claimed in claim 1, characterized in that the blocking means comprise a resilient adhesive over time allowing the mobile portions to be stuck together.

4. The unfoldable card as claimed in claim 3, characterized in that the blocking means comprise a supple elastic band comprising at least one adhesive face adhered with said resilient adhesive, this band being adapted to stick together the first and second mobile portions and thus position the card in its closed configuration.

5. The unfoldable card as claimed in claim 1, characterized in that the first and second mobile portions are flat surfaces.

6. The unfoldable card as claimed in claim 1, characterized in that the elastic means comprise an elastic hinge fixed on each of the mobile portions, said hinge forming an axis of rotation of the mobile portions relative to one another, thus allowing alternative passage of the card from one configuration to the other.

7. The unfoldable card as claimed in claim 6, characterized in that the elastic hinge comprises a flat elastic band fixed on a first edge of the first mobile portion and on a second edge of the second mobile portion.

8. The unfoldable card as claimed in claim 7, characterized in that the elastic means in the form of flat elastic band is inserted and stuck at connection points arranged respectively in the thickness of each of the mobile portions so as to allow an elastic link between these two mobile portions.

9. The unfoldable card as claimed in claim 1, characterized in that it comprises a decorative piece fixed on the card and suitable to be hidden by the mobile portions when the card is in its closed configuration.

10. The unfoldable card as claimed in claim 9, characterized in that the decorative piece is a detachable decoration fixed on the card via attachment means integral with the card at the attachment point between the mobile portions.

11. The unfoldable card as claimed in claim 10, characterized in that assembly between the attachment means integral with the card and the detachable decoration is completed by at least one attachment of male/female type.

12. The unfoldable card as claimed in claim 10, characterized in that it comprises a secondary decorative piece, fixed on the detachable decorative piece.

13. The unfoldable card as claimed in claim 9, characterized in that it comprises a secondary decorative piece, fixed on the decorative piece.
